(19) United States
(12) Patent Application Publication
(10) Pub. No.: US 2012/0001951 A1
(43) Pub. Date: Jan. 5, 2012

(54) LIQUID CRYSTAL DISPLAY

(75) Inventor: Koichi KATAGAWA, Tokyo (JP)

(73) Assignee: Sony Corporation, Tokyo (JP)

(21) Appl. No.: 13/158,740

(22) Filed: Jun. 13, 2011

(30) Foreign Application Priority Data
Jun. 30, 2010 (JP) 2010-148505

(51) Int. Cl. G09G 3/36; G09G 5/10

(52) U.S. Cl. 345/690; 345/88

(57) ABSTRACT

A liquid crystal display includes: a light source section; a liquid crystal display panel including pixels corresponding to a plurality of colors; an overdrive processing section performing predetermined overdrive processing on an input picture signal; a gain correction section performing a predetermined gain correction on the overdrive-processed picture signal; and a drive section performing a display-drive based on the gain-corrected picture signal. The liquid crystal display panel includes a pair of substrates and liquid crystal cells forming the pixels. A plurality of values corresponding to respective colors of the pixels are provided for cell gaps of the liquid crystal cells. The overdrive processing section performs common overdrive processing for pixels of respective colors, and the gain correction section performs different gain corrections corresponding to respective values of the cell gaps.

### BACKGROUND

The present disclosure relates to a liquid crystal display with use of a multi-gap structure including a plural kinds of cell gaps.

In recent years, flat panel displays as typified by liquid crystal TVs and plasma display panels (PDPs) have become a trend, and most of mobile displays are liquid crystal displays, and precise color reproducibility is desired in the mobile displays.

A typical liquid crystal display has a configuration in which a liquid crystal layer is sandwiched (sealed) between a substrate (a TFT substrate) including a pixel electrode, a TFT (Thin Film Transistor) or the like thereon and a substrate (a facing substrate) including a facing electrode, a color filter or the like thereon. The color filter is divided into color segments, and the color segments are provided for pixels corresponding to red (R), green (G) and blue (B), respectively. Therefore, pixels corresponding to R, pixels corresponding to G and pixels corresponding to B display red, green and blue, respectively, to achieve color display on a whole liquid crystal display.

It is known that viewing angle characteristics of such a liquid crystal display are heavily dependent on a gap (a cell gap of a liquid crystal cell) between the substrates with the liquid crystal layer in between. More specifically, an effective thickness (a retardation; a cell gap d×a refractive anisotropy Δn of a liquid crystal composite forming the liquid crystal layer) of the liquid crystal layer when the transmittance of light (display light) passing through the liquid crystal layer is at maximum is changed depending on the wavelength of the light passing through the liquid crystal layer. Therefore, the transmittances of display light through the above-described pixels of R, G and B are different from one another.

Therefore, Japanese Unexamined Patent Application Publication No. H7-159770 discloses a liquid crystal display with a multi-gap structure having plural kinds of cell gap values by allowing a color filter to have different thicknesses depending on the wavelength of display light (corresponding to the pixels of R, G and B, respectively). In the liquid crystal display with the multi-gap structure, for example, different cell gap values are provided for the pixels of R, G and B, respectively. Therefore, in the liquid crystal display with the multi-gap structure, compared to a liquid crystal display with a typical structure (a structure in which the cell gap value is common to the pixels of respective colors) in related art, the transmittance of display light is allowed to be increased, and high luminance is achieved.

### SUMMARY

In liquid crystal displays, to prevent an issue caused by low liquid crystal response speed to improve motion picture characteristics, various techniques have been proposed. One of the techniques is, for example, overdrive processing (for example, refer to Japanese Examined Patent Application Publication No. H8-8671 and Japanese Unexamined Patent Application Publication No. 2005-208600). The overdrive processing is a process of changing the luminance gradation of a picture signal in a present frame period according to a difference in luminance gradation between the picture signal in the present frame period and a picture signal in a preceding frame period (a luminance gradation transition state). By the overdrive processing, a voltage (a drive voltage) applied to pixels at the time of a display-drive is corrected (a rising edge of an optical response waveform of a liquid crystal becomes steeper), and the liquid crystal response speed is allowed to be improved accordingly.

Therefore, it may be considered that when such overdrive processing is adopted in the liquid crystal display with the above-described multi-gap structure, motion picture characteristics is improved in addition to high luminance characteristics and display image quality is further improved.

However, when the overdrive processing is adopted in the liquid crystal display with the multi-gap structure, the following issue arises. When a cell gap value is changed, the liquid crystal response speed is changed accordingly; therefore, the liquid crystal response speeds in pixels corresponding to respective colors (for example, pixels of R, G and B) are different from one another. As a result, in a whole liquid crystal display, a coloring phenomenon (a phenomenon in which a color is shifted from a chromaticity point specified by a picture signal) occurs.

To reduce (or prevent) the coloring phenomenon caused by the multi-gap structure, a technique of using different LUTs (lookup tables) corresponding to respective colors (respective pixels with different cell gap values) is considered. However, when this technique is used, the number of kinds of LUTs is increased to cause, for example, an increase in capacity of a memory, thereby causing an increase in cost.

As described above, in the liquid crystal display with the multi-gap structure, it is difficult to reduce the coloring phenomenon caused by overdrive processing without increase in cost; therefore, a technique for solving this issue is desired.

It is desirable to provide a liquid crystal display allowed to improve display image quality at low cost while using a multi-gap structure.

According to an embodiment of the disclosure, there is provided a liquid crystal display including: a light source section; a liquid crystal display panel including pixels corresponding to a plurality of colors and displaying a picture by modulating light applied from the light source section; an overdrive processing section performing predetermined overdrive processing on an input picture signal; a gain correction section performing a predetermined gain correction on the overdrive-processed picture signal; and a drive section performing a display-drive on the pixels in the liquid crystal display panel based on the gain-corrected picture signal. The above-described liquid crystal display panel includes a pair of substrates and liquid crystal cells arranged between the pair of substrates, the liquid crystal cells forming the pixels. A plurality of values corresponding to respective colors of the pixels are provided for cell gaps of the liquid crystal cells. The above-described overdrive processing section performs common overdrive-processing for pixels of respective colors according to a luminance gradation transition state of the input picture signal, and the above-described gain correction section performs different gain corrections corresponding to respective values of the cell gaps according to the luminance gradation transition state of the input picture signal.

In the liquid crystal display according to the embodiment of the disclosure, different gain corrections corresponding to the respective value of the cell gaps of the liquid crystal cells are performed on the overdrive-processed picture signal according to the luminance gradation transition state of the input picture signal. Then, the display-drive is performed on the pixels in the crystal display panel based on the gain-corrected picture signal. Therefore, variations, caused by different values of the cell gaps, in liquid crystal response speed between pixels of different colors (between liquid crystal cells with different cell gaps) at the time of the display-drive using the overdrive processing are reduced. Moreover, in the overdrive processing, common processing for the pixels of respective colors is performed according to the luminance gradation transition state of the input picture signal. Therefore, in the overdrive processing, for example, it is not necessary to use different LUTs (lookup tables) corresponding to respective colors (respective liquid crystal cells with different cell gap values), thereby preventing an increase in cost.

In the liquid crystal display according to the embodiment of the disclosure, different gain corrections corresponding to the values of the cell gaps of the liquid crystal cells are performed on the overdrive-processed picture signal according to the luminance gradation transition state of the input picture signal, and the display-drive is performed on the pixels in the liquid crystal display panel based on the gain-corrected picture signal; therefore, variations in response speed between pixels of different colors at the time of the display-drive using overdrive processing are allowed to be reduced, thereby reducing a coloring phenomenon. Moreover, common overdrive processing for pixels of respective colors is performed according to the luminance gradation transition state of the input picture signal; therefore, an increase in cost is preventable. Accordingly, in a liquid crystal display with use of a multi-gap structure, display image quality is allowed to be improved at low cost.

Other and further objects, features and advantages of the disclosure will appear more fully from the following description.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a block diagram illustrating a whole configuration of a liquid crystal display according to an embodiment of the disclosure.

FIG. 2 is a circuit diagram illustrating a specific configuration example of a pixel illustrated in FIG. 1.

FIG. 3 is a schematic sectional view illustrating a configuration example of a liquid crystal display panel illustrated in FIG. 1.

FIG. 4 is a block diagram illustrating a specific configuration example of an overdrive processing section illustrated in FIG. 1.

FIG. 5 is a schematic view illustrating an example of an overdrive processing LUT illustrated in FIG. 4.

FIG. 6 is an illustration for describing typical overdrive processing in a transition of a picture signal from a low gradation to a high gradation.

FIG. 7 is an illustration for describing typical overdrive processing in a transition of a picture signal from a high gradation to a low gradation.

FIG. 8 is a schematic view for describing use states of LUTs in typical overdrive processing according to Comparative Example 1.

FIG. 9 is a timing waveform chart for describing an issue (a coloring phenomenon) in the case where overdrive processing according to Comparative Example 1 is applied to a liquid crystal display panel with a multi-gap structure.

FIG. 10 is a schematic view for describing use states of LUTs in overdrive processing according to Comparative Example 2.

FIG. 11 is a block diagram illustrating a configuration example of an overdrive processing section according to Comparative Example 3.

FIG. 12 is a flow chart illustrating overdrive processing and gain correction according to Comparative Example 3.

FIG. 13 is a timing waveform chart for describing an issue arising in the case where overdrive processing and gain correction according to Comparative Example 3 are used.

FIG. 14 is a flow chart illustrating an example of overdrive processing and gain correction according to the embodiment.

FIG. 15 is a schematic view illustrating an example of a gain correction LUT illustrated in FIG. 4.

FIG. 16 is a schematic sectional view illustrating a configuration of a liquid crystal display panel according to a modification.

### DETAILED DESCRIPTION OF THE PREFERRED EMBODIMENTS

A preferred embodiment of the disclosure will be described in detail below referring to the accompanying drawings. Descriptions will be given in the following order.

1. Embodiment (Example of a liquid crystal display panel in which different cell gaps are provided for pixels of R, G and B, respectively)
2. Modification (Example of a liquid crystal display panel in which cell gaps for pixels of R and G are different from a cell gap for pixels of B, and so on)

### Embodiment

### [Whole Configuration of Liquid Crystal Display]

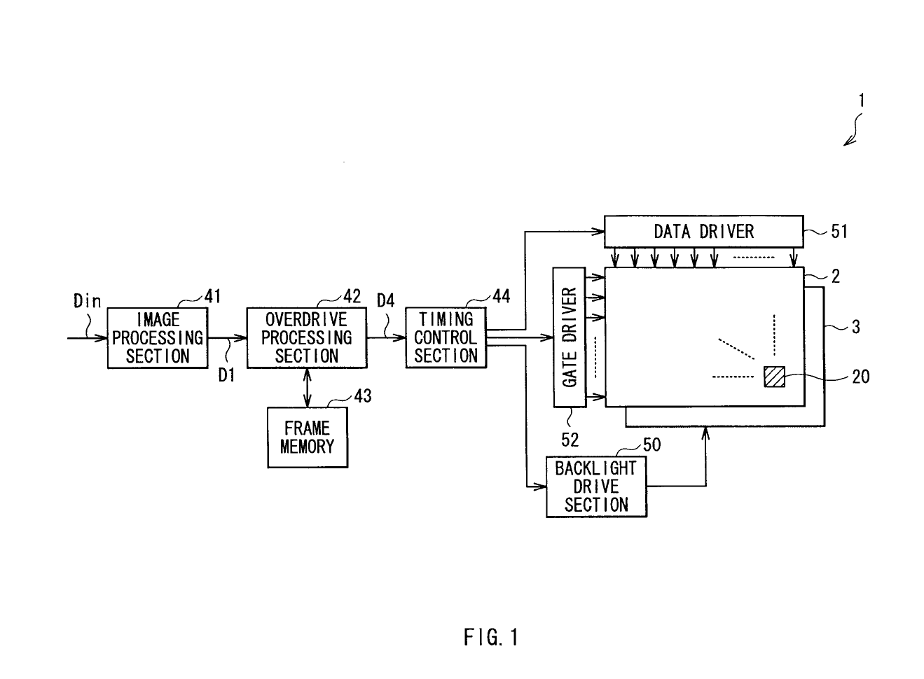

FIG. 1 illustrates a block configuration of a liquid crystal display (a liquid crystal display 1) according to an embodiment of the disclosure. The liquid crystal display 1 is a so-called transmissive liquid crystal display, and includes a backlight 3 (a light source section) and a transmissive liquid crystal display panel 2. The liquid crystal display 1 includes an image processing section 41, an overdrive processing section 42, a frame memory 43, a timing control section 44, a backlight drive section 50, a data driver 51 and a gate driver 52. The timing control section 44, the data driver 51 and the gate driver 52 correspond to specific examples of “a drive section” in the disclosure.

The backlight 3 is a light source applying light to the liquid crystal display panel 2, and is configured of, for example, an LED (Light Emitting Diode) or a CCFL (Cold Cathode Fluorescent Lamp).

### (Liquid Crystal Display Panel 2)

The liquid crystal display panel 2 modulates light emitted from the backlight 3 based on a picture voltage supplied from the data driver 51 which will be described later in response to a drive signal supplied from the gate driver 52 which will be described later to display a picture based on an input picture signal Din. The liquid crystal display panel 2 includes a plurality of pixels 20 arranged in a matrix form as a whole.

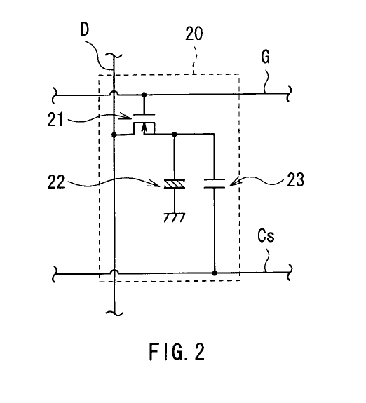

FIG. 2 illustrates a circuit configuration example of a pixel circuit in each pixel 20. The pixel 20 includes a liquid crystal element 22, a TFT element 21 and an auxiliary capacitance element 23. A gate line G for line-sequentially selecting a pixel to be driven, a data line D for supplying a picture voltage (a picture voltage supplied from the data driver 51) to the pixel to be driven and an auxiliary capacitance line Cs are connected to the pixel 20.

The liquid crystal element 22 performs a display operation in response to a picture voltage supplied from the data line D to one end thereof through the TFT element 21. The liquid crystal element 22 is configured by sandwiching a liquid crystal layer (a liquid crystal layer 204 which will be described later) made of, for example, a VA (Vertical Alignment) mode or TN (Twisted Nematic) mode liquid crystal between a pair of electrodes (a pixel electrode 203 and a facing electrode 205 which will be described later). One (one end) of the pair of electrodes in the liquid crystal element 22 is connected to a drain of the TFT element 21 and one end of the auxiliary capacitance element 23, and the other (the other end) of the pair of electrodes is grounded. The auxiliary capacitance element 23 is a capacitance element for stabilizing an accumulated charge of the liquid crystal element 22. One end of the auxiliary capacitance element 23 is connected to the one end of the liquid crystal element 22 and the drain of the TFT element 21, and the other end of the auxiliary capacitance element 23 is connected to the auxiliary capacitance line Cs. The TFT element 21 is a switching element for supplying a picture voltage to the one end of the liquid crystal element 22 and the one end of the auxiliary capacitance element 23, and is configured of a MOS-FET (Metal Oxide Semiconductor-Field Effect Transistor). A gate and a source of the TFT element 21 are connected to the gate line G and the data line D, respectively, and the drain of the TFT element 21 is connected to the one end of the liquid crystal element 22 and the one end of the auxiliary capacitance element 23.

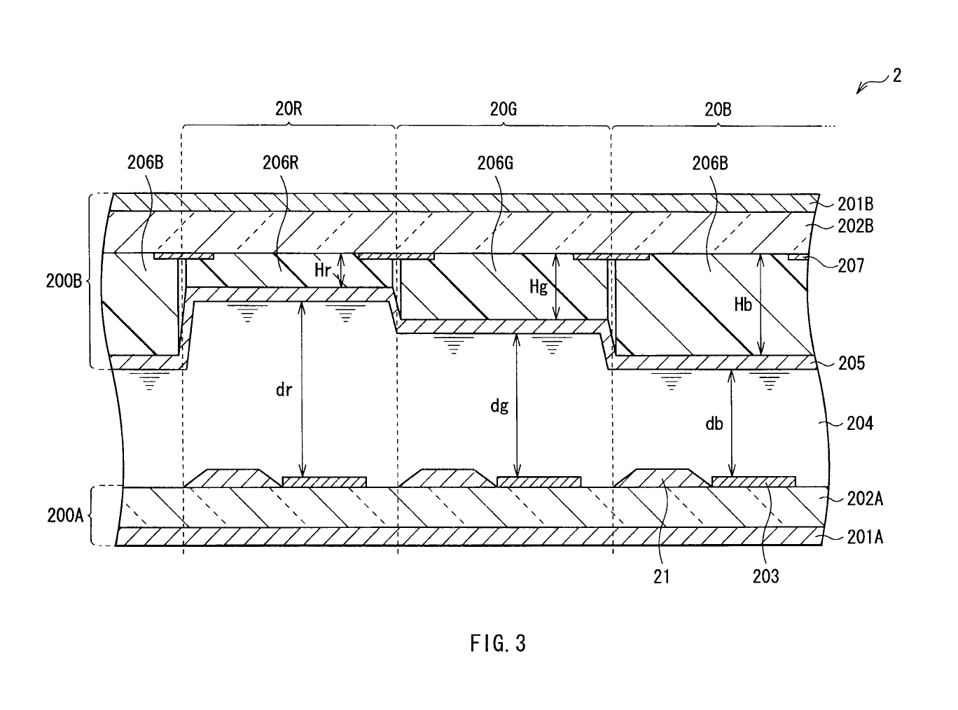

FIG. 3 schematically illustrates a sectional configuration example of the liquid crystal display panel 2. In the liquid crystal display panel 2, as the above-described pixels 20, pixels corresponding to a plurality of colors, that is, pixels 20R corresponding to red (R), pixels 20G corresponding to green (G) and pixels 20B corresponding to blue (B) are arranged. The pixels 20R, 20G and 20B are arranged in a matrix form in the liquid crystal display panel 2. The liquid crystal display panel 2 has a configuration in which a liquid crystal layer 204 (a liquid crystal cell) forming each of the pixels 20R, 20G and 20B are sandwiched (sealed) between a TFT substrate 200A and a facing substrate 200B (between a pair of substrates).

In the TFT substrate 200A, drive elements such as the pixel electrodes 203 and the TFT elements 21 are formed on a surface (a surface close to the liquid crystal layer 204) of a transparent substrate 202A made of, for example, glass. The pixel electrodes 203 and the TFT elements 21 are provided for the pixels 20R, 20G and 20B, respectively.

In the facing substrate 200B, a black matrix (BM) layer 207, color filters 206R, 206G and 206B and the facing electrode 205 are formed in this order on a surface (a surface close to the liquid crystal layer 204) of a transparent substrate 202B made of, for example, glass. The color filter 206R is arranged in the pixel 20R and is a filter allowing red light to pass therethrough. The color filter 206G is arranged in the pixel 20G and is a filter allowing green light to pass therethrough. The color filter 206B is arranged in the pixel 20B and is a filter allowing blue light to pass therethrough. In other words, the color filters 206R, 206G and 206B are provided for the pixels 20R, 20G and 20B, respectively. Therefore, the pixels 20R, 20G and 20B display red, green and blue, respectively, to achieve color display on a whole liquid crystal display 1. The black matrix layer 207 is arranged in a boundary region between the pixels 20R, 20G and 20B, and functions as a light-shielding layer shielding light. The facing electrode 205 is uniformly formed on the facing substrate 200B, and is a common electrode for the pixels 20R, 20G and 20B.

In this case, in the liquid crystal display panel 2, a plurality of values corresponding to colors of the pixels 20R, 20G and 20B are provided for cell gaps (distances between the TFT substrate 200A and the facing substrate 200B) of liquid crystal cells. In other words, the liquid crystal display panel 2 has a multi-gap structure. More specifically, as illustrated in FIG. 3, a cell gap dr in the pixel 20R, a cell gap dg in the pixel 20G and a cell gap db in the pixel 20B have values different from one another (dr>dg>db), because of the following reason.

First, viewing angle characteristics of a typical liquid crystal display are heavily dependent on cell gaps of liquid crystal cells. More specifically, an effective thickness (a retardation; a cell gap d×a refractive anisotropy Δn of a liquid crystal composite forming a liquid crystal layer) of the liquid crystal layer when a transmittance T of light (display light) passing through the liquid crystal layer is at maximum is dependent on a wavelength λ of display light passing through the liquid crystal layer. More specifically, in the case where u=(2d×Δn/λ) is established, the transmittance T of display light is typically represented by the following expression (1). Therefore, in the typical liquid crystal display (in which the value of a cell gap d is common to pixels of different colors) in related art, the transmittances T of display light through the pixels of respective colors (for example, the above-described pixels 20R, 20G and 20B) are different from one another.

T=sin²[((1+u²)^{1/2}·π/2)/(1+u²)] (1)

Therefore, in the liquid crystal display panel 2 in the embodiment, the above-described multi-gap structure is achieved by allowing the color filters 206R, 206G and 206B to have different film thicknesses depending on the wavelength λ of display light. More specifically, first, λr>λg>λb is established, where the wavelengths λ of red light passing through the pixel 20R, green light passing through the pixel 20G and blue light passing through the pixel 20B are λr, λg and λb, respectively. Therefore, in this case, the film thicknesses Hr, Hg and Hb of the color filters 206R, 206G and 206B, respectively, are set to establish Hr<Hg<Hb, thereby setting the values of the cell gaps dr, dg and db to establish dr>dg>db as described above. Accordingly, in the liquid crystal display panel 2, the transmittance T of display light is allowed to be set at maximum independently of the wavelength λ of display light. Therefore, in the liquid crystal display 1, compared to the typical liquid crystal display (in which the value of the cell gap d is common to pixels of different colors) in related art, the transmittance of display light is allowed to be increased, and high luminance is achievable.

The image processing section 41 illustrated in FIG. 1 performs predetermined image processing (for example, a contrast improvement process or a sharpness improvement process) on the input picture signal Din externally supplied to output a picture signal subjected to such image processing to the overdrive processing section 42.

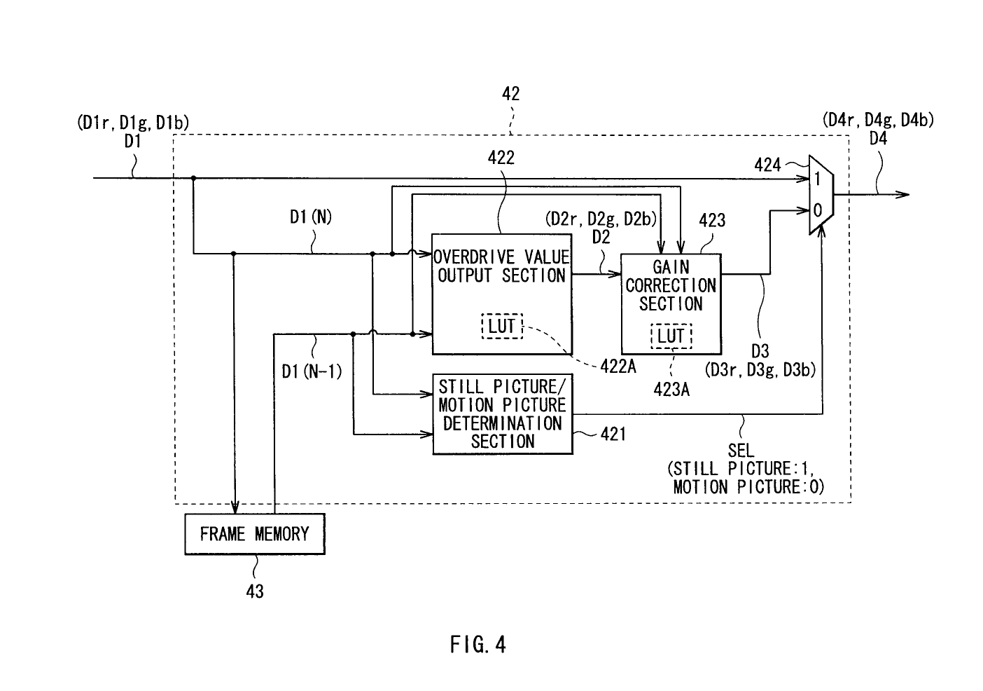

The overdrive processing section 42 performs predetermined overdrive processing which will be described later on a picture signal D1 supplied from the image processing section 41, and performs predetermined gain correction which will be described later on the overdrive-processed picture signal, thereby generating a picture signal D4. Herein, the picture signal D1 corresponds to a specific example of “an input picture signal” in the disclosure. A specific configuration of the overdrive processing section will be described later (refer to FIG. 4).

The frame memory 43 is used to perform the above-described overdrive processing and the above-described gain correction in the overdrive processing section 42, and is a frame memory temporarily storing the picture signal D1. As such a frame memory, for example, various memories such as a SRAM (Static Random Access Memory) are allowed to be used.

The timing control section 44 controls drive timing of the backlight drive section 50, the gate driver 52 and the data driver 51, and supplies, to the data driver 51, the picture signal D4 supplied from the overdrive processing section 42.

The gate driver 52 performs a line-sequential writing drive on the pixels 20 in the liquid crystal display panel 2 along the above-described gate line G in response to timing control by the timing control section 44.

The data driver 51 supplies, to each of the pixels 20 of the liquid crystal display panel 2, a picture voltage based on the picture signal supplied from the timing control section 44. More specifically, the data driver 51 performs D/A (digital/analog) conversion on the picture signal to generate a picture signal (the above-described picture voltage) as an analog signal and then transmit the analog signal to each of the pixels 20.

The backlight drive section 50 controls a lighting operation (a light emission operation) of the backlight 3 in response to timing control by the timing control section 44.

### [Specific Configuration of Overdrive Processing Section 42]

FIG. 4 illustrates a block diagram of a specific configuration example of the overdrive processing section 42 with the frame memory 43. The overdrive processing section 42 includes a still picture/motion picture determination section 421, an overdrive value output section 422, a gain correction section 423 and a selector 424. The overdrive value output section 422 corresponds to a specific example of “an overdrive processing section” in the disclosure, and the gain correction section 423 corresponds to a specific example of “a gain correction section” in the disclosure.

It is to be noted that in the drawing, picture signals D1r, D1g and D1b mean picture signals D1 corresponding to the pixel 20R, the pixel 20G and the pixel 20B, respectively. Likewise, picture signals D2r, D2g and D2b mean picture signals D2 corresponding to the pixel 20R, the pixel 20G and the pixel 20B, respectively, picture signals D3r, D3g and D3b mean picture signals D3 corresponding to the pixel 20R, the pixel 20G and the pixel 20B, respectively, and picture signals D4r, D4g and D4b mean picture signals D4 corresponding to the pixel 20R, the pixel 20G and the pixel 20B, respectively. Moreover, a picture signal D1(N) means a picture signal D1 in a present frame period (a frame period N), and a picture signal D1(N−1) means a picture signal D1 in a preceding frame period (a frame period (N−1)).

The still picture/motion picture determination section 421 determines whether the picture signal D1(N) is a still picture or a motion picture based on the picture signal D1(N) in the present frame period supplied from the image processing section 41 and the picture signal D1(N−1) in the preceding frame period stored in the frame memory 43. More specifically, as will be described in detail later, the still picture/motion picture determination section 421 determines whether the picture signal D1(N) is a still picture or a motion picture based on whether a difference in luminance gradation between the picture signal D1(N) and the picture signal D1(N−1) is larger than a predetermined set value (a threshold value). When it is determined as a result of such determination that the picture signal D1(N) is a still picture, a selection control signal SEL=“1” is generated, and when it is determined that the picture signal D1(N) is a motion picture, a selection control signal SEL=“0” is generated.

The overdrive value output section 422 performs common overdrive processing on the picture signals D1r, D1g and D1b corresponding to respective colors according to a luminance gradation transition state of the picture signal D1 to generate the picture signals D2 as resultants of the overdrive-processing. More specifically, the overdrive value output section 422 determines the luminance gradations of the picture signals D2 (D2r, D2g and D2b) in the present frame period according to the luminance gradation of the picture signal D1(N) in the present frame period and the luminance gradation of the picture signal D1(N−1) in the preceding frame period. At this time, the overdrive value output section 422 performs such overdrive processing with use of, for example, a predetermined common LUT (an overdrive processing LUT 422A) for the picture signals D1r, D1g and D1b.

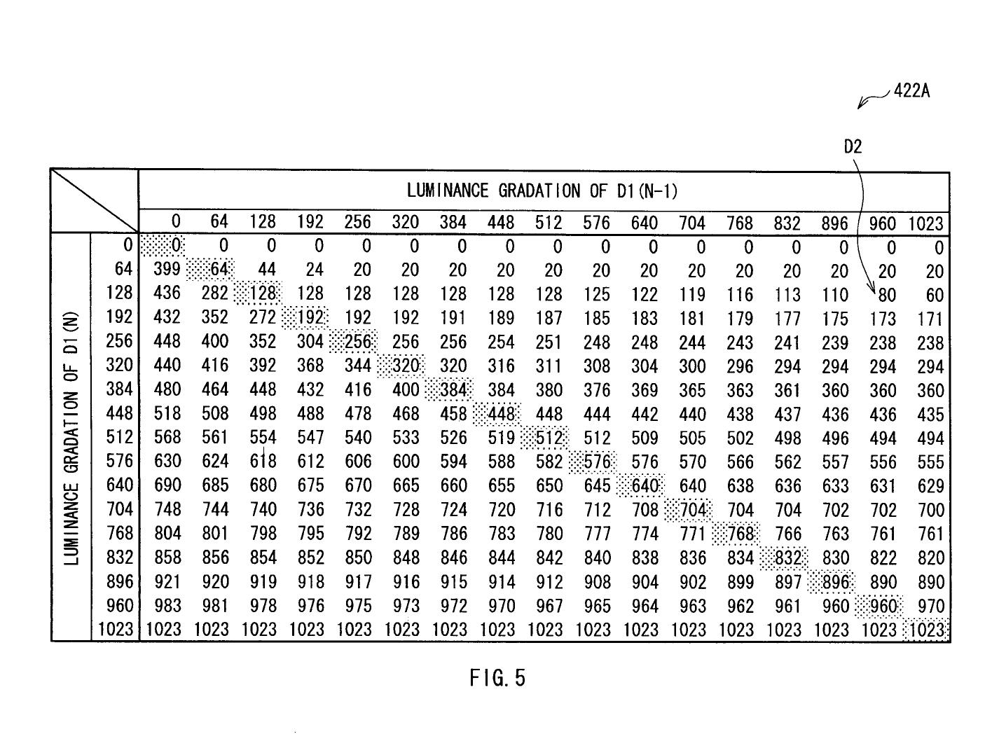

FIG. 5 schematically illustrates an example of the overdrive processing LUT 422A. In the overdrive processing LUT 422A, the luminance gradation of the picture signal D1(N) in the present frame period, the luminance gradation of the picture signal D1(N−1) in the preceding frame period and the luminance gradation of the picture signal D2 in the present frame period are specified in relation to one another. In this case, the luminance gradations of the picture signals D1(N), D1(N−1) and D2 fall in a range of gradations of 1 to 1023 as an example. Moreover, in FIG. 5, only some of these gradations are typically illustrated. In the overdrive processing LUT 422A, the luminance gradation of the picture signal D2 is basically set to allow a difference in luminance gradation between the picture signals D2 and D1(N−1) to be larger than a difference in luminance gradation between the picture signals D1(N) and D1(N−1).

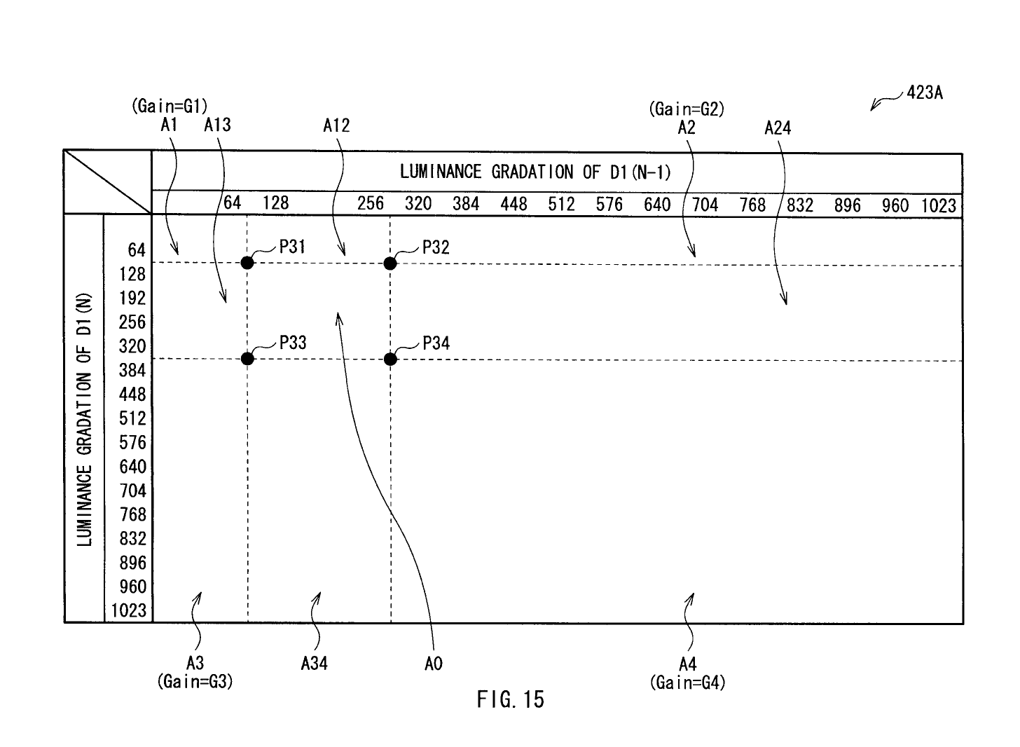

The gain correction section 423 performs different gain corrections on the picture signals D2 (resultants of overdrive processing) corresponding to the respective pixels 20 with different cell gap values according to the luminance gradation transition state of the picture signal D1 to generate the picture signals D3 as resultants of the gain corrections. More specifically, different gain corrections by color are performed on the picture signals D2 (D2r, D2g and D2b) in the present frame period according to the luminance gradation of the picture signal D1(N) in the present frame period and the luminance gradation of the picture signal D1(N−1) in the preceding frame period. Therefore, the luminance gradations of the picture signals D3 (D3r, D3g and D3b) in the present frame period are determined. At this time, the gain correction section 423 performs gain corrections by multiplying the picture signals D2r, D2g and D2b by gain values Gain corresponding to the cell gap values dr, dg and db (corresponding to the picture signals D2r, D2g and D2b), respectively. Moreover, the gain correction section 423 performs such gain corrections with use of, for example, predetermined different LUTs (gain correction LUTs 423A) corresponding to the picture signals D2r, D2g and D2b, respectively. As will be described in detail later (refer to FIG. 15), the gain correction LUTs 423A specify the luminance gradation of the picture signal D1(N) in the present frame period, the luminance gradation of the picture signal D1(N−1) in the preceding frame period and the gain value Gain in relation to one another. The gain corrections in the gain correction section 423 will be described in detail later.

The selector 424 selectively outputs one of the picture signal D1 (D1r, D1g and D1b) and the picture signal D3 (D3r, D3g and D3b) as a resultant of the gain correction according to the value of the selection control signal SEL supplied from the still picture/motion picture determination section 421. The selector 424 outputs the picture signal selected in such a manner as a picture signal D4 (D4r, D4g and D4b). More specifically, the selector 424 outputs the picture signal D1 as the picture signal D4 in the case where the selection control signal SEL is “1” (in the case of a still picture). In other words, the selector 424 outputs, as the picture signal D4, the picture signal D1 supplied from the image processing section 41 as it is without being subjected to overdrive processing and a gain correction. On the other hand, in the case where the selection control signal SEL is “0” (in the case of a motion picture), the selector 424 outputs the picture signal D3 as the picture signal D4. In other words, the selector 424 outputs the overdrive-processed and gain-corrected picture signal D3 as the picture signal D4.

### [Functions and Effect of Liquid Crystal Display]

Next, functions and effects of the liquid crystal display 1 according to the embodiment will be described below.

### (1. Brief Description of Display Operation)

In the liquid crystal display 1, as illustrated in FIG. 1, first, the image processing section 41 performs the above-described predetermined image processing on the input picture signal Din to generate the picture signal D1 as a resultant of the image processing. Next, the overdrive processing section 42 performs predetermined overdrive processing and predetermined gain correction which will be described later on the picture signal D1 to generate the picture signal D4. Next, the picture signal D4 is supplied from the overdrive processing section 42 to the data driver 51 through the timing control section 44. The data driver 51 performs a D/A conversion on the picture signal D4 to generate a picture voltage as an analog signal. Then, a display-drive operation is performed on the pixels 20 by a drive voltage supplied from the gate driver 52 and the data driver 51 to each of the pixels 20.

More specifically, as illustrated in FIG. 2, ON/OFF operations of the TFT element 21 are switched in response to a selection signal supplied from the gate driver 52 through the gate line G. Therefore, conduction is selectively established between the data line D and the liquid crystal element 22 and the auxiliary capacitance element 23. As a result, a picture voltage supplied from the data driver 51 is supplied to the liquid crystal element 22, and a display-drive operation is performed.

In the pixels 20 in which conduction is established between the data line D, the liquid crystal element 22 and the auxiliary capacitance element 23, illumination light from the backlight 3 is modulated in the liquid crystal display panel 2 to be emitted as display light. Thus, a picture based on the input picture signal Din is displayed on the liquid crystal display 1.

### (2. Overdrive Processing and so on)

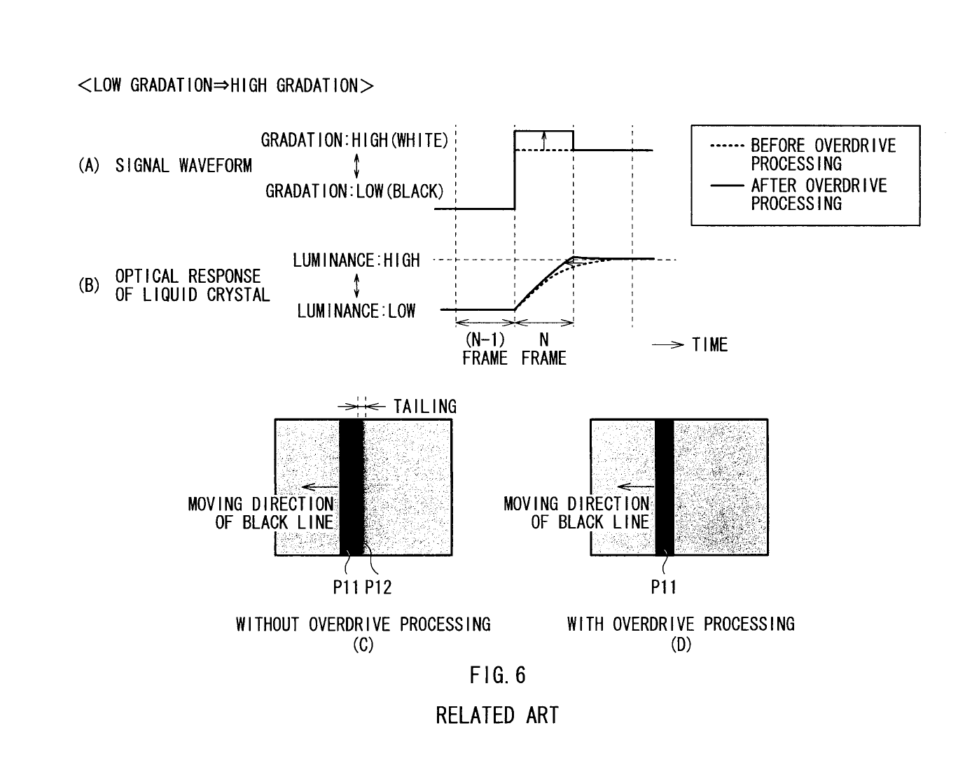

Next, referring to FIGS. 6 to 15, as one of characteristics parts of the disclosure, the overdrive processing (and the gain correction) by the overdrive processing section 42 will be described in detail below in comparison with comparative examples (Comparative Examples 1 to 3).

### Comparative Example 1

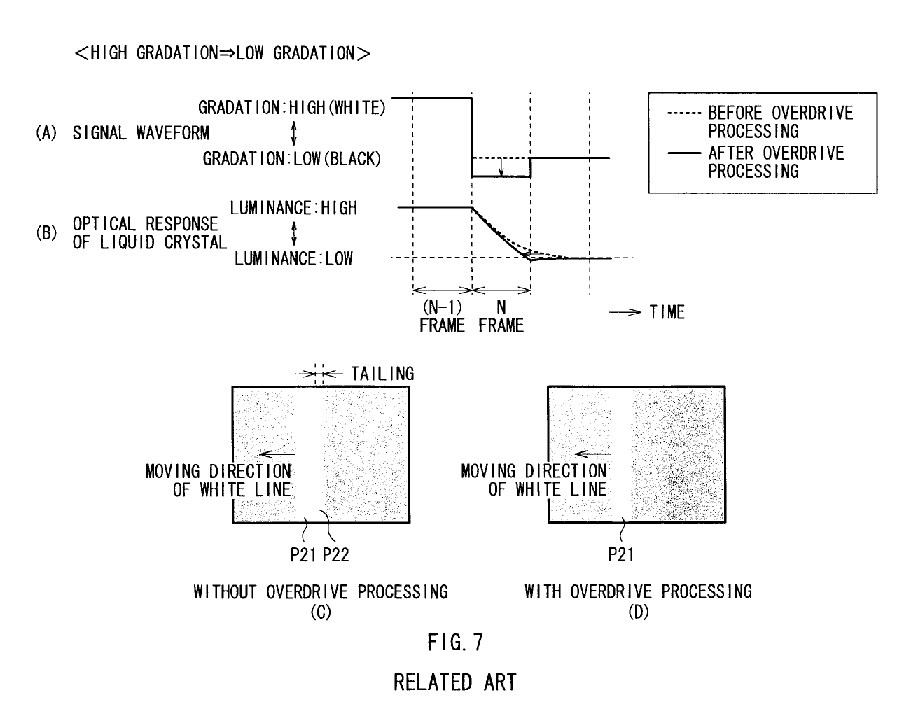

FIGS. 6 and 7 briefly illustrate typical overdrive processing in related art according to Comparative Example 1. More specifically, FIG. 6 briefly illustrates overdrive processing when the picture signal is changed from a low gradation to a high gradation, and FIG. 7 briefly illustrates overdrive processing when the picture signal is changed from a high gradation to a low gradation. In these drawings, parts (A) and (B) illustrate timing charts of a signal waveform of the picture signal and an optical response waveform of a liquid crystal, respectively. Moreover, parts (C) and (D) schematically illustrate display states when a black line (refer to FIG. 6) or a white line (refer to FIG. 7) is moved on a screen in the case where overdrive processing is used and in the case where overdrive processing is not used.

First, in a transition from a low gradation (a black side) to a high gradation (a white side) illustrated in FIG. 6, as indicated by an arrow in the part (A) in FIG. 6, overdrive processing is performed by increasing the luminance gradation of the picture signal in the present frame period (an N-frame period) (by changing the luminance gradation of the picture signal to a white side). Therefore, as indicated by an arrow in the part (B) in FIG. 6, a voltage (a drive voltage) applied to the pixels at the time of a display-drive is corrected (a rising edge of the optical response waveform of the liquid crystal becomes steeper) to improve liquid crystal response speed. Therefore, in the case where the overdrive processing is not used (refer to the part (C) in FIG. 6), when a black line represented by a reference numeral P11 in the drawing is moved on the screen, tailing represented by a reference numeral P12 in the drawing is generated. On the other hand, in the case where the overdrive processing is used (refer to the part (D) in FIG. 6), tailing is not generated.

On the other hand, in a transition from a high gradation (the white side) to a low gradation (the black side) illustrated in FIG. 7, as indicated by an arrow in the part (A) in FIG. 7, overdrive processing is performed by reducing the luminance gradation of the picture signal in the present frame period (the N-frame period) (by changing the luminance gradation of the picture signal to the black side). Therefore, as indicated by an arrow in the part (B) in FIG. 7, the drive voltage is corrected (a rising edge of the optical response waveform of the liquid crystal becomes steeper) at the time of a display-drive to improve the liquid crystal response speed. Therefore, in the case where the overdrive processing is not used (refer to the part (C) in FIG. 7), when a white line represented by a reference numeral P21 in the drawing is moved on the screen, tailing represented by a reference numeral P22 in the drawing is generated. On the other hand, in the case where the overdrive processing is used (refer to the part (D) in FIG. 7), tailing is not generated.

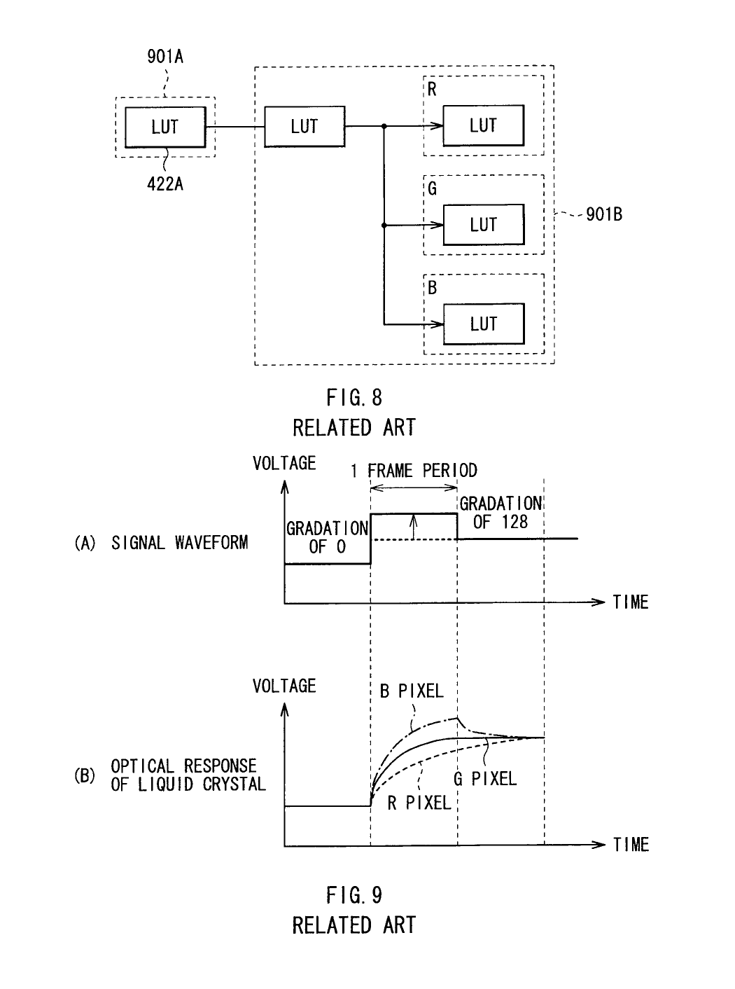

In the case of such overdrive processing in related art, the overdrive processing LUT 422A is used, for example, as illustrated in FIG. 8. In other words, first, one common LUT 422A for the picture signals of R, G and B is provided for an external memory 901A of an IC (integrated circuit) 901B for overdrive processing. Moreover, one common primary buffer LUT for the picture signals R, G and B is provided for the IC 901B, and different LUTs (but used data is common to R, G and B) corresponding to respective colors of R, G and B are provided for an actual processing block.

However, in the case where such overdrive processing in related art is applied to the liquid crystal display panel 2 with the multi-gap structure illustrated in, for example, FIG. 3, the following issue arises. For example, as illustrated in parts (A) and (B) in FIG. 9, when the cell gap values dr, dg and db are different from one another, the liquid crystal response speed varies depending on the cell gap values dr, dg and db; therefore, in the case where the overdrive processing is used, the liquid crystal response speeds in the pixels 20R, 20G and 20B are different from one another. As a result, in a whole liquid crystal display, a coloring phenomenon (a phenomenon in which a color is shifted from a chromaticity point specified by a picture signal) occurs. More specifically, an example illustrated in the part (B) in FIG. 9, a magnitude relation of cell gaps is dr>dg>db, so the liquid crystal response speed is high in order of an R pixel (the pixel 20R), a G pixel (the pixel 20G) and a B pixel (the pixel 20B), thereby causing a coloring phenomenon to a blue direction as a whole.

### Comparative Example 2

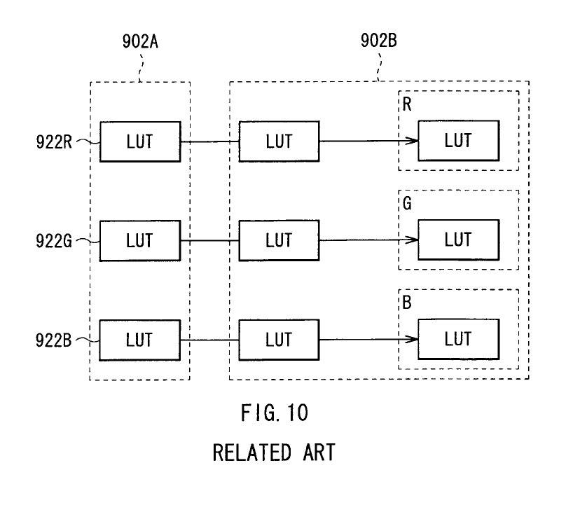

As in the case of Comparative Example 2 illustrated in, for example, FIG. 10, it is considered to use an overdrive processing LUT in overdrive processing. In other words, in Comparative Example 2, to reduce a coloring phenomenon caused by the multi-gap structure in the above-described Comparative Example 1, in overdrive processing, different overdrive processing LUTs for respective colors (respective pixels 20 with different cell gap values) are used. More specifically, different overdrive processing LUTs 922R, 922G and 922B for respective picture signals of R, G and B are used in both of an external memory 902A and an IC 902B for overdrive processing (a primary buffer and an actual processing block).

However, in the case where a technique in Comparative Example 2 is used, the number of kinds of overdrive processing LUTs is increased (the number of LUTs is increased to three for R, G and B); therefore, the capacity of the external memory 902A and the capacity of a memory in the IC 902B are increased to cause an increase in cost.

### Comparative Example 3

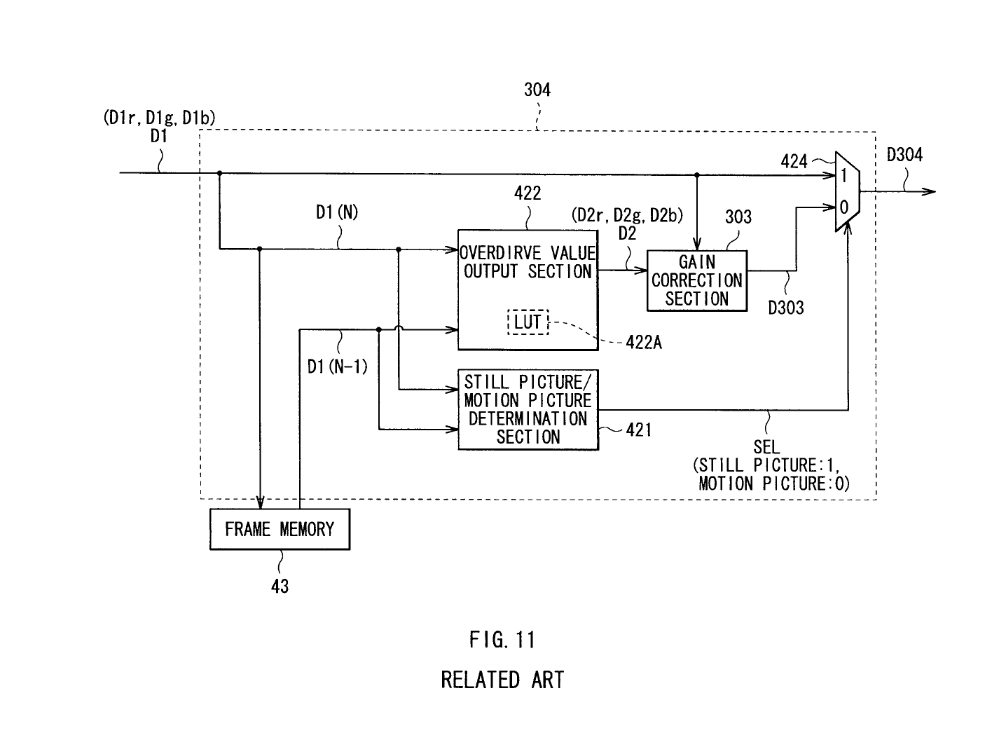

On the other hand, in Comparative Example 3 illustrated in FIGS. 11 to 13, the overdrive processing in related art (in Comparative Example 1) is performed on the picture signal, and then a predetermined gain correction is performed on the overdrive-processed picture signal. However, in the gain correction in Comparative Example 3, as will be described below, unlike the gain correction in the embodiment, the gain correction is performed with use of a fixed gain value independent of a luminance gradation transition state of the picture signal.

FIG. 11 illustrates a block configuration of an overdrive processing section (an overdrive processing section 304) according to Comparative Example 3 together with the frame memory 43. The overdrive processing section 304 has the same configuration as the overdrive processing section 42 in the embodiment illustrated in FIG. 4, except that instead of the gain correction section 423, a gain correction section 303 is included.

The gain correction section 303 performs, on the picture signals D2 as resultants of the overdrive processing, different gain corrections for the picture signals D2r, D2g and D2b corresponding to the pixels 20 with different cell gap values, respectively, to output picture signals D303 as resultants of the gain corrections. In this case, the picture signals D3 are configured of picture signals D303r, D303g and D303b corresponding to R, G and B, respectively. At this time, the gain correction section 303 performs gain corrections by multiplying the picture signals D2r, D2g and D2b by different gain values Gain corresponding to the cell gap values dr, dg and db (corresponding to the picture signals D2r, D2g and D2b), respectively. However, unlike the gain correction section 423 in the embodiment, the gain correction section 303 performs gain corrections without using the gain correction LUT 423A. In other words, unlike the gain correction section 423, the gain correction section 303 performs gain corrections with use of the fixed gain value Gain independent of luminance gradation transition states of the picture signal D1(N) in the present frame period and the picture signal D1(N−1) in the preceding frame period.

Therefore, the selector 424 selectively outputs one of the picture signal D1 (D1r, D1g and D1b) and the picture signal D303 (D303r, D303g and D303b) as the resultant of the gain correction according to the value of the selection control signal SEL. Then, the selector 424 outputs the picture signal selected in such a manner as a picture signal D304 (D304r, D304g and D304b corresponding to R, G and B).

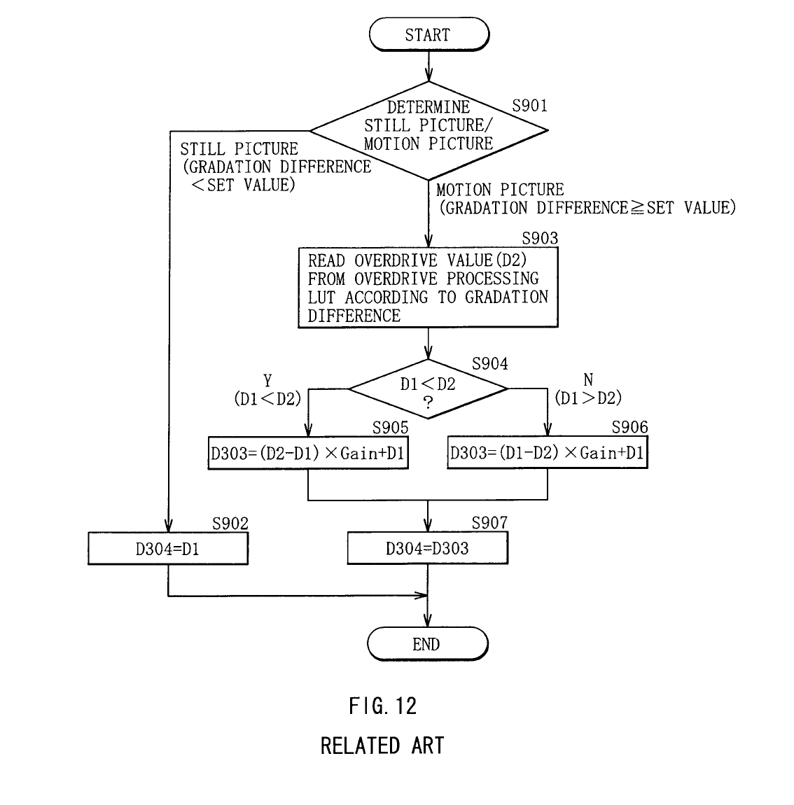

FIG. 12 illustrates a flow chart of the overdrive processing and the gain correction according to Comparative Example 3.

First, as described above, the still picture/motion picture determination section 421 determines whether the picture signal D1(N) is a still picture or a motion picture (step S901). More specifically, the still picture/motion picture determination section 421 determines whether the picture signal D1(N) is a still picture or a motion picture based on whether a difference in luminance gradation between the picture signal D1(N) and the picture signal D1(N−1) is smaller than a predetermined set value (a threshold value). When the difference in luminance gradation is smaller than the set value and it is determined that the picture signal D1(N) is a still picture in the step S901, the selector 424 outputs the picture signal D1 as a picture signal D304 (D304=D1) (Step S902). In other words, as the picture signal D1(N) is a still picture in this case, it is not necessary to perform the overdrive processing and the gain correction which will be describe below; therefore, a whole process illustrated in FIG. 12 is completed.

On the other hand, when the difference in luminance gradation is equal to or larger than the set value and it is determined that the picture signal D1(N) is a motion picture in the step S901, the overdrive processing and the gain correction which will be described below are performed. In other words, first, the overdrive value output section 422 reads a picture signal D2 (an overdrive value) from the overdrive processing LUT 422A according to luminance gradation transition states of the picture signal D1(N) and the picture signal D1(N−1) (a difference in luminance gradation) (step S903). Therefore, the overdrive value output section 422 outputs the picture signal D2 as a resultant of the overdrive processing on the picture signal D1.

Next, the gain correction section 303 determines a magnitude relation between luminance gradations of the picture signal D1 (D1(N)) to be subjected to the overdrive processing in the present frame period and the picture signal D2 as the resultant of the overdrive processing in the present frame period. More specifically, in this case, the gain correction section 303 determines whether the luminance gradation of the picture signal D1 is smaller (lower) than the luminance gradation of the picture signal D2 (D1<D2) (step S904).

In the case where it is determined that (D1<D2) is established (step S904: Y), the gain correction section 303 performs a gain correction by the following expression (2) with use of a fixed gain value Gain independent of the luminance gradation transition states of the picture signals D1(N) and D1(N−1) (step S905). Therefore, the picture signal D303 as a resultant of the gain correction on the picture signal D2 is generated. On the other hand, in the case where it is determined that (D1>D2) is established (step S904: N), the gain correction section 303 performs a gain correction by the following expression (3) with use of the above-described fixed gain value Gain (step S906). Therefore, the picture signal D303 as a resultant of the gain correction on the picture signal D2 is generated.

D303=(D2−D1)×Gain+D1 (2)

D303=(D1−D2)×Gain+D1 (3)

Next, the selector 424 outputs the picture signal D303, as a resultant of the gain correction, generated in such a manner as the picture signal D304 (D304=D303) (step S907). Therefore, the whole process illustrated in FIG. 12 is completed.

Thus, in Comparative Example 3, in the overdrive processing, as in the case of the above-described Comparative Example 1, common processing for respective colors (the picture signals D1r, D1g and D1b) is performed according to the luminance gradation transition state of the picture signal D1. Therefore, unlike the above-described Comparative Example 2, it is not necessary to use different overdrive processing LUTs corresponding to respective colors (respective pixels 20 with different cell gap values) in the overdrive processing, thereby preventing an increase in cost.

Moreover, different gain corrections for respective colors (the respective pixels 20 with different cell gap values) are performed on the picture signal D2 as a resultant of the overdrive processing. Then, a display-drive is performed on the pixels 20R, 20G and 20B in the liquid crystal panel based on the picture signals D303 as resultants of the gain corrections. Therefore, in Comparative Example 3, compared to the above-described Comparative Example 1, a coloring phenomenon at the time of a display-drive with use of the overdrive processing is reduced or prevented.

However, in the gain correction in Comparative Example 3, unlike the gain correction in the embodiment which will be described later, as described above, the fixed gain value Gain independent of the luminance gradation transition state of the picture signal D1 is used. The following issue caused by this arises in Comparative Example 3.

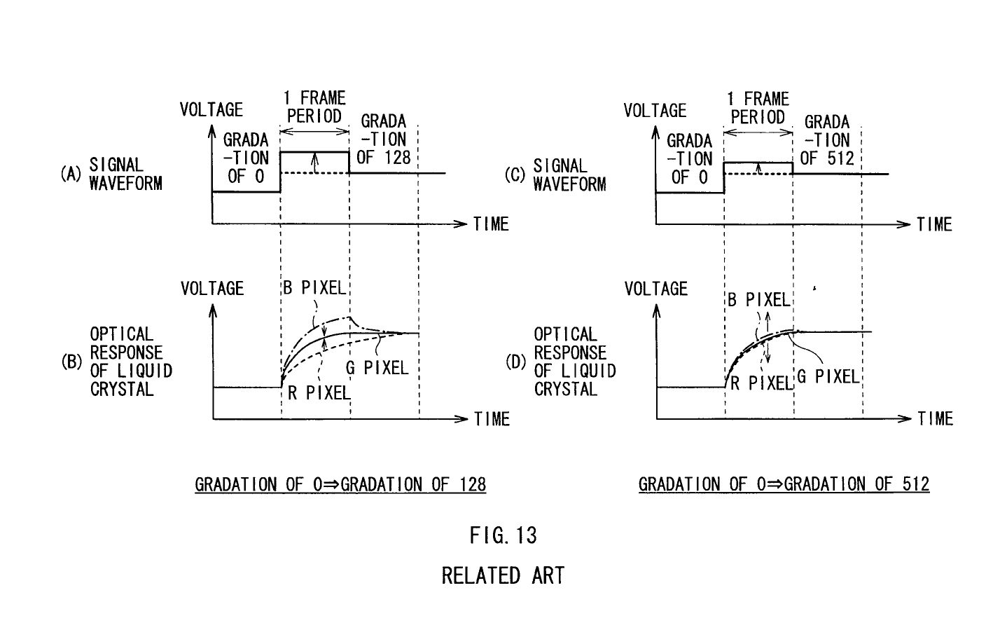

FIG. 13 illustrates an issue in the case where the overdrive processing and the gain correction according to Comparative Example 3 are used with use of a timing waveform chart. More specifically, parts (A) and (B) illustrate waveforms in a transition from a gradation of 0 to a gradation of 128 as an example, and parts (C) and (D) illustrate waveforms in a transition from a gradation of 0 to a gradation of 512 as an example. Moreover, the parts (A) and (C) each illustrate a signal waveform of a picture signal and the parts (B) and (D) each illustrate an optical response waveform of a liquid crystal.

First, in the transition from a gradation of 0 to a gradation of 128 illustrated in the parts (A) and (B) in FIG. 13, in the case where the gain correction in Comparative Example 3 is not performed, the same coloring phenomenon as that described above referring to FIG. 9 occurs. In other words, the liquid crystal response speed is high in order of the R pixel (the pixel 20R), the G pixel (the pixel 20G) and the B pixel (the pixel 20B), thereby causing a coloring phenomenon to a blue direction as a whole.

On the other hand, in the transition from a gradation of 0 to a gradation of 512 illustrated in the parts (C) and (D) in FIG. 13, unlike the case of the transition from a gradation of 0 to a gradation of 128, a coloring phenomenon hardly occurs. In other words, the liquid crystal response speeds in the R pixel (the pixel 20R), the G pixel (the pixel 20G) and the B pixel (the pixel 20B) are substantially equal to one another.

Thus, in the liquid crystal display with the multi-gap structure, a range of variations in response speed between the pixels 20R, 20G and 20B in the overdrive processing are largely changed depending on the luminance gradation transition state of the picture signal. In other words, there are the case of a luminance gradation transition state in which the response speeds are different form one another, thereby causing a significant coloring phenomenon as illustrated in the parts (A) and (B) in FIG. 13, and the case of a luminance gradation transition state in which the response speeds are substantially equal to one another, thereby hardly causing a coloring phenomenon as illustrated in the parts (C) and (D) in FIG. 13.

Therefore, as in the case of Comparative Example 3, in the case where the gain correction is performed with use of the fixed gain value Gain independent of the luminance gradation transition state of the picture signal D1, an effect of preventing (reducing) the coloring phenomenon is changed depending on the luminance gradation transition state. Moreover, in some cases, when such a gain correction is performed, the coloring phenomenon may occur. More specifically, for example, as indicated by an arrow in the part (B) in FIG. 13, in the transition from a gradation of 0 to a gradation of 128, a fixed gain value Gain allowing the response speeds in the R pixel and the B pixel to be equal to the response speed in the G pixel is used, the occurrence of the coloring phenomenon is virtually prevented in this luminance gradation transition state. However, even if the gain value Gain is used in any other luminance gradation transition state, an effect of preventing (reducing) the coloring phenomenon may be hardly exerted. Moreover, for example, as indicated by an arrow in the part (D) in FIG. 13, when the gain value Gain is used in a transition from a gradation of 0 to a gradation of 512, the gain correction causes the coloring phenomenon. More specifically, in this example, the liquid crystal response speed is high in order of the B pixel (the pixel 20B), the G pixel (the pixel 20G) and the R pixel (the pixel 20R), thereby causing a coloring phenomenon to a red direction as a whole.

### Embodiment

Therefore, in the embodiment, in the overdrive processing section 42 illustrated in FIG. 4, the following overdrive processing and the following gain correction are performed. More specifically, first, the overdrive value output section 422 performs common overdrive processing on the picture signals D1r, D1g and D1b corresponding to respective colors according to the luminance gradation transition state of the picture signal D1 to output the picture signals D2 as resultants of the overdrive processing. Then, the gain correction section 423 performs different gain corrections on respective picture signals D2r, D2g and D2b corresponding to the pixels 20R, 20G and 20B with different cell gap values according to the luminance gradation transition state of the picture signal D1 to generate the picture signals D3 as resultants of the gain corrections. Therefore, in the embodiment, while having the same advantages as those in Comparative Example 3, the issue described referring to FIG. 13 in Comparative Example 3 is preventable. Such overdrive processing in the embodiment will be described in detail below.

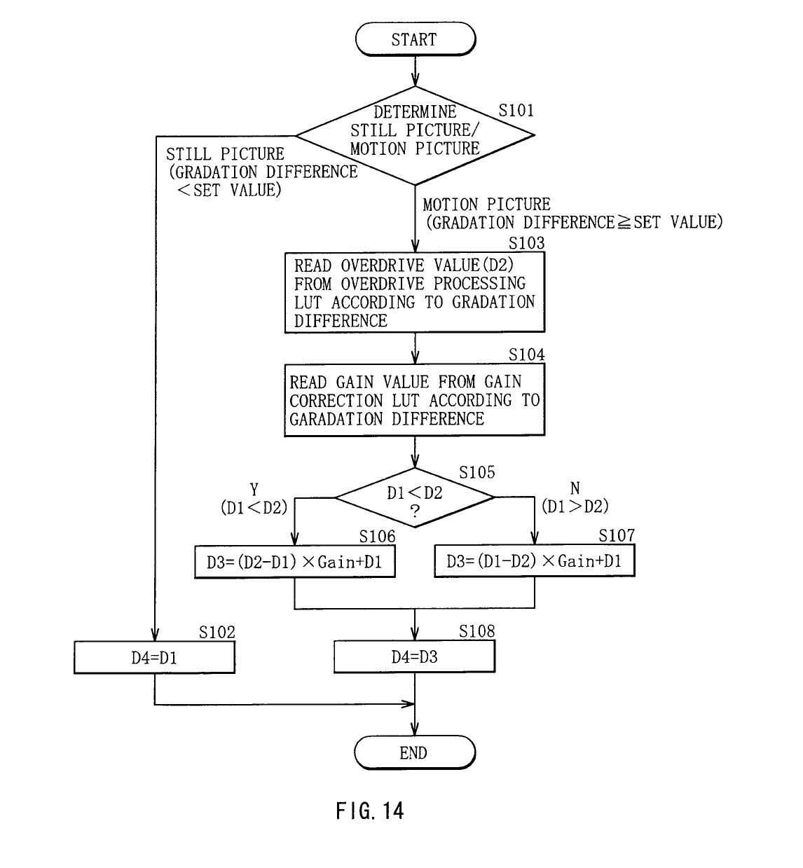

FIG. 14 illustrates a flow chart of the overdrive processing and the gain correction in the embodiment. First, in the embodiment, as in the case of Comparative Example 3 illustrated in FIG. 12 (steps S901 to S903), processes in the steps S101 to S103 are performed. In other words, still picture/motion picture determination by the still picture/motion picture determination section 421 (step S101), a process of outputting the picture signal D1 as the picture signal D4 by the selector 424 (step S102) and the overdrive processing by the overdrive value output section 422 (step S103) are performed.

Next, in the embodiment, the gain correction section 423 reads different gain values Gain corresponding to respective colors R, G and B from the gain correction LUT 423A according to the luminance gradation transition states of the picture signal D1(N) and the picture signal D1(N−1) (a luminance gradation difference) (step S104).

Next, as in the case of the step S904 in Comparative Example 3, the gain correction section 423 determines whether the luminance gradation of the picture signal D1 is smaller (lower) than the luminance gradation of the picture signal D2 (D1<D2) (step S105).

In the case where it is determined that (D1<D2) is established (step S105: Y), the gain correction section 423 performs a gain correction by the following formula (4) with use of the gain value Gain according to the luminance gradation transition states of the picture signals D1(N) and D1(N−1) (step S106). Therefore, the picture signal D3 as a resultant of the gain correction on the picture signal D2 is generated. On the other hand, in the case where it is determined that (D1>D2) is established (step S105: N), the gain correction section 423 performs a gain correction by the following expression (5) with use of the gain value Gain according to the above-described luminance gradation transition states (step S107). Therefore, the picture signal D3 as a resultant of the gain correction on the picture signal D2 is generated. Thus, the gain correction section 423 performs gain corrections by multiplying the picture signals D2r, D2g and D2b by different gain values Gain corresponding to the cell gap values dr, dg and db (corresponding to the picture signals D2r, D2g and D2b), respectively.

D3=(D2−D1)×Gain+D1 (4)

D3=(D1−D2)×Gain+D1 (5)

Next, as in the case of the step S907 in Comparative Example 3, the selector 424 outputs the picture signal D3, as a resultant of the gain correction, generated in such a manner as the picture signal D4 (D4=D3) (step S108). Therefore, the whole process illustrated in FIG. 14 is completed.

FIG. 15 schematically illustrates an example of a gain correction LUT 423A used in the above-described gain correction. In the gain correction LUT 423A, the luminance gradation of the picture signal D1(N) in the present frame period, the luminance gradation of the picture signal D1(N−1) in the preceding frame period, and different gain values Gains corresponding to respective colors (respective picture signals D2r, D2g and D2b) are specified in relation to one another. In this case, the luminance gradations of the picture signals D1(N) and D1(N−1) fall in a range of gradations of 0 to 1023 as an example. Moreover, in FIG. 15, only some of these gradations are typically illustrated. In the gain correction LUT 423A, the gain values Gain are set to allow the response waveforms of liquid crystal in the pixels 20R, 20G and 20B according to the luminance gradation transition state to be substantially equal to one another independent of the cell gap value at the time of a display-drive.

Moreover, in the gain correction LUT 423A, a setting region of the gain value Gain is divided into a plurality of sub-regions (in this case, four sub-regions A1, A2, A3 and A4) according to the luminance gradation transition states of the picture signals D1(N) and D1(N−1). More specifically, in the setting region of the gain value Gain, an upper left part (on low gradation sides of the picture signals D1(N) and D1(N−1)) from a luminance transition point P31 in the drawing is the sub-region A1. An upper right part (on a low gradation side of the picture signal D1(N) and a high gradation side of the picture signal D1(N−1)) from a luminance transition point P32 in the drawing is the sub-region A2. A lower left part (on a high gradation side of the picture signal D1(N) and a low gradation side of the picture signal D1(N−1)) from a luminance transition point P33 in the drawing is the sub-region A3. A lower right part (on high gradation sides of the picture signals of D1(N) and D1(N−1)) from a luminance transition point P34 in the drawing is the sub-region A4. In these sub-regions A1 to A4, the gain values Gain in the sub-regions A1, A2, A3 and A4 are G1, G2, G3 and G4, respectively. In other words, the gain values Gain corresponding to respective sub-regions A1 to A4 are provided. It is to be noted that the gain values G1, G2, G3 and G4 collectively mean gain values provided corresponding to respective colors of R, G and B. In this case, some of the gain values G1, G2, G3 and G4 may be the same as one another, or the magnitude relation of the gain values G1, G2, G3 and G4 may be arbitrarily set to reduce (prevent) a coloring phenomenon at the time of a display-drive. As an example, it is considered to set a magnitude relation of (G1<G2=G3=G4).

Moreover, in the gain correction LUT 423A, in boundary regions (in this case, 5 boundary regions A12, A13, A24, A34 and A0) between adjacent sub-regions of the plurality of sub-regions A1 to A4, the gain value Gain is generated by interpolation. In this case, the boundary region A12 is a boundary region between the sub-regions A1 and A2 (a region located between the sub-regions A1 and A2). Moreover, the boundary region A13 is a boundary region between the sub-regions A1 and A3 (a region located between the sub-regions A1 and A3). The boundary region A24 is a boundary region between the sub-regions A2 and A4 (a region located between the sub-regions A2 and A4). The boundary region A34 is a boundary region between the sub-regions A3 and A4 (a region located between the sub-regions A3 and A4). The boundary region A0 is a boundary region between the sub-regions A1, A2, A3 and A4 (a region located between the sub-regions A1, A2, A3 and A4), and in this case, the boundary region A0 is a rectangular region formed inside four luminance transition points P31, P32, P33 and P34. The gain values Gain corresponding to the boundary regions A12, A13, A24, A34 and A0 are allowed to be represented by the following expression (6). It is to be noted that coefficients α1 to α5, β1 to β5, γ5 and δ5 are interpolation coefficients for generation by interpolation.

Boundary region A12:Gain=G1×α1+G2×β1

Boundary region A13:Gain=G1×α2+G3×β2

Boundary region A24:Gain=G2×α3+G4×β3

Boundary region A34:Gain=G3×α4+G4×β4

Boundary region A0:Gain=G1×α5+G2×β5+G3×γ5+G4×δ5 (6)

Thus, in the embodiment, different gain corrections corresponding to respective cell gap values are performed on the picture signal D2 as a resultant of the overdrive processing according to the luminance gradation transition state of the picture signal D1. Then, a display-drive is performed on the pixels 20R, 20G and 20B in the liquid crystal display panel 2 based on the picture signals D3 as resultants of the gain corrections. Therefore, variations, caused by different cell gap values, in liquid crystal response speed between the pixels 20R, 20G and 20B of different colors (between the pixels 20 with different cell gaps) at the time of a display-drive with use of the overdrive processing are reduced. Further, in the overdrive processing, common processing for the pixels 20R, 20G and 20B of respective colors is performed according to the luminance gradation transition state of the picture signal D1. Therefore, in the overdrive processing, it is not necessary to use different overdrive processing LUTs corresponding to respective colors (respective pixels 20R, 20G and 20B with different cell gap values), thereby preventing an increase in cost.

As described above, in the embodiment, different gain corrections corresponding to respective cell gap values are performed on the picture signal D2 as a resultant of the overdrive processing according to the luminance gradation transition state of the picture signal D1, and a display-drive is performed on the pixels 20R, 20G and 20B in the liquid crystal display panel 2 based on the picture signals D3 as the resultants of the gain corrections; therefore, variations in response speed between the pixels 20R, 20G and 20B of different colors at the time of a display-drive with use of the overdrive processing are allowed to be reduced, thereby reducing a coloring phenomenon. Moreover, common overdrive processing for the pixels 20R, 20G and 20B of respective colors is performed according to the luminance gradation transition state of the picture signal D1; therefore, an increase in cost is preventable. Accordingly, in the liquid crystal display with the multi-gap structure, display image quality is allowed to be improved at low cost.

### (Modifications)

Although the present disclosure is described referring to the embodiment and the modifications, the disclosure is not limited thereto, and may be variously modified.

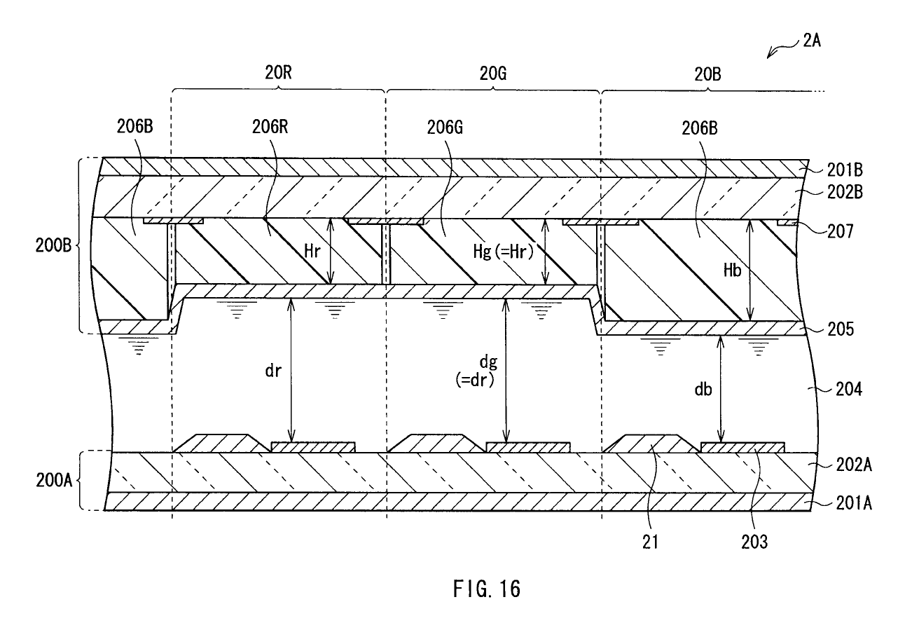

For example, the case where the cell gaps of respective pixels 20R, 20G and 20B have values different from one another (dr>dg>db) is described; however, it is only necessary to provide plural kinds of cell gap values, and any other multi-gap structure may be used. In other words, for example, as in the case of a liquid crystal display panel 2A illustrated in FIG. 16, cell gaps of the pixels 20R and 20G may have the same values, and the cell gap of the pixel 20B may have a smaller value than those of the pixels 20R and 20G (dr=dg>db). Therefore, in this case, the thicknesses of the color filters 206R, 206G and 206B have a magnitude relation of Hr=Hg<Hb. In the liquid crystal display panel 2A with such a multi-gap structure, the overdrive processing and the gain correction described in the above-described embodiment are applicable, and the same effects as those in the embodiment are allowed to be obtained.

Moreover, the values and configurations of the overdrive processing LUT and the gain correction LUT described in the above-described embodiment are not limited to those illustrated in FIGS. 5 and 15, and any other configuration or any other value may be used.

Further, the block configuration of the overdrive processing section is not limited to that described in the above-described embodiment, and any other block configuration may be used.

In addition, in the above-described embodiment, the case where the pixels 20 includes the pixels 20R corresponding to red (R), the pixels 20G corresponding to green (G) and the pixels 20B corresponding to blue (B) is described; however, the number and kinds of colors of the pixels 20 are not limited thereto, and any other colors may be used.

Moreover, in the above-described embodiment, a normally black mode liquid crystal is described; however, the disclosure is also applicable to a normally white mode liquid crystal.

In addition, the operations of the overdrive processing and the gain correction described in the above-described embodiment may be performed by hardware (a circuit) or software (a program).

The present application contains subject matter related to that disclosed in Japanese Priority Patent Application JP 2010-148505 filed in the Japan Patent Office on Jun. 30, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display comprising:
a light source section;
a liquid crystal display panel including pixels corresponding to a plurality of colors and displaying a picture by modulating light applied from the light source section;
an overdrive processing section performing predetermined overdrive processing on an input picture signal;
a gain correction section performing a predetermined gain correction on the overdrive-processed picture signal; and
a drive section performing a display-drive on the pixels in the liquid crystal display panel based on the gain-corrected picture signal,
wherein the liquid crystal display panel includes a pair of substrates and liquid crystal cells arranged between the pair of substrates, the liquid crystal cells forming the pixels,
a plurality of values corresponding to respective colors of the pixels are provided for cell gaps of the liquid crystal cells,
the overdrive processing section performs common overdrive processing for pixels of respective colors according to a luminance gradation transition state of the input picture signal, and
the gain correction section performs different gain corrections corresponding to respective values of the cell gaps according to the luminance gradation transition state of the input picture signal.

2. The liquid crystal display according to claim 1, wherein
the gain correction section performs the gain correction by multiplying the overdrive-processed picture signal by different gain values corresponding to the respective values of the cell gaps.

3. The liquid crystal display according to claim 2, wherein
the gain correction section performs the gain correction with use of a predetermined gain correction LUT (lookup table) specifying the luminance gradation transition state of the input picture signal and the gain values in relation to each other.

4. The liquid crystal display according to claim 3, wherein
in the gain correction LUT, a setting region of the gain values is divided into a plurality of sub-regions according to the luminance gradation transition state of the input picture signal.

5. The liquid crystal display according to claim 4, wherein
in a boundary region between adjacent sub-regions of the plurality of sub-regions, the gain value is generated by interpolation.

6. The liquid crystal display according to claim 1, wherein
the gain correction section performs the gain correction to allow response waveforms of the liquid crystal cells in the pixels according to the luminance gradation transition state to be substantially equal to one another at the time of the display-drive independent of the values of the cell gaps.

7. The liquid crystal display according to claim 1, wherein
the pixels include pixels corresponding to red (R), pixels corresponding to green (G) and pixels corresponding to blue (B).

8. The liquid crystal display according to claim 7, wherein
the cell gaps in respective pixels corresponding to R, G and B have values different from one another.

9. The liquid crystal display according to claim 7, wherein
the cell gaps in the pixels corresponding to R and G have values equal to each other and the cell gap in the pixels corresponding to B has a smaller value than those in the pixels corresponding to R and G.
